(19) United States
(12) Patent Application Publication
(10) Pub. No.: US 2014/0063800 A1
(43) Pub. Date: Mar. 6, 2014

(54) LIGHTING DEVICE FOR AN LED LAMP

(71) Applicant: Min-Hwa CHOU, Tainan (TW)

(72) Inventor: Min-Hwa CHOU, Tainan (TW)

(21) Appl. No.: 13/601,006

(22) Filed: Aug. 31, 2012

(51) Int. Cl. F21V 21/00; F21V 5/04

(52) U.S. Cl. 362/237

(57) ABSTRACT

A lighting device has a holder, multiple LED modules and multiple light-homogenized elements. The holder has an axis and multiple working surfaces. The axis is defined axially through the pillar and the base. The working surfaces are formed in an outer side surface of the holder and are arranged around the axis. The LED modules are respectively mounted on the working surfaces of the holder. The light-homogenized elements are respectively mounted on the working surfaces of the holder. Therefore, the LED modules are respectively positioned on the working surfaces to increase the illumination of the side area of the lighting device, and the light-homogenized effect of the light emitted from the lighting device is improved by the light-homogenized elements.

### BACKGROUND OF THE INVENTION

1. Field of the Invention

The present invention relates to a lighting device, and more particularly to a lighting device for an LED lamp to provide a light-homogenized effect.

2. Description of Related Art

An LED (light emitting diode) is a point light source and has characterizations of small volume, high luminance, low energy-consumption and long service life. Therefore, the LED has come into wide use in car lamps, flashlights etc. Taking a car lamp for example, the car lamp has a seat, a lighting device and a lampshade. A chamber is formed in the seat. An opening is formed in the seat and in communication with the chamber. The lighting device is mounted on the seat and has a base, a circuit board and an LED. The base has a working surface facing the opening of the seat. The circuit board is mounted on the working surface of the base. The LED is mounted on the circuit board and has a light-emitting end facing the opening of the seat. The lampshade is mounted on the seat and closes the opening of the seat.

However, a light emitting angle of the LED is narrow, and the lighting device provides only a working surface facing the opening of the seat. Therefore, the light emitted from the LED of the lighting device mostly illuminates a front area of the car lamp. Thus, although the illumination of the front area of the car lamp is sufficient, the illumination of the side area of the car lamp is insufficient. Thus, the light-homogenized effect of the conventional lighting device is poor.

To overcome the shortcomings, the present invention tends to provide a lighting device to mitigate or obviate the aforementioned problems.

### SUMMARY OF THE INVENTION

The main objective of the invention is to provide a lighting device for an LED lamp to improve the light-homogenized effect of the light emitted from the lighting device.

The lighting device for an LED lamp has a holder, multiple LED modules and multiple light-homogenized elements. The holder has a base and a pillar. The pillar is mounted on the base and has an axis and multiple working surfaces. The axis is defined axially through the pillar and the base. The working surfaces are formed in an outer side surface of the pillar and are arranged around the axis of the pillar. The LED modules are respectively mounted on the working surfaces of the holder and each LED module has a circuit board and at least one LED. Each circuit board is mounted on a corresponding one of the working surfaces of the holder. The at least one LED is mounted on a corresponding one of the circuit boards. The light-homogenized elements are respectively mounted on the working surfaces of the holder and each light-homogenized element has a body and a lens. Each body is mounted on a corresponding one of the working surfaces of the holder and extends across a corresponding one of the circuit boards. Each lens is formed in the body and has a light input surface facing the at least one LED of a corresponding one of the LED modules.

The lighting device for an LED lamp is mounted on a seat and a lampshade is mounted on the seat and outside the lighting device. The light emitting from the at least one LED of the lighting device passes through a corresponding one of the lenses and out from the lampshade. Therefore, the at least one LED is positioned on a corresponding one of the working surfaces to increase the illumination of the side area of the LED lamp, and the light-homogenized effect of the light emitted from the lighting device is improved by the lenses of the light-homogenized elements.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a lighting device for an LED lamp in accordance with the present invention;

FIG. 2 is a side view of the lighting device for an LED lamp in FIG. 1;

FIG. 3 is an operational side view in partial section of the lighting device for an LED lamp in FIG. 1 combined with a seat and a lampshade;

FIG. 4 is a perspective view of a second embodiment of a lighting device for an LED lamp in accordance with the present invention;

FIG. 5 is a side view of the lighting device for an LED lamp in FIG. 4;

FIG. 6 is an exploded perspective view of a third embodiment of a lighting device for an LED lamp in accordance with the present invention;

FIG. 7 is a top view of a fourth embodiment of a lighting device for an LED lamp in accordance with the present invention; and

FIG. 8 is a side view of a fifth embodiment of a lighting device for an LED lamp in accordance with the present invention.

### DETAILED DESCRIPTION OF PREFERRED EMBODIMENT

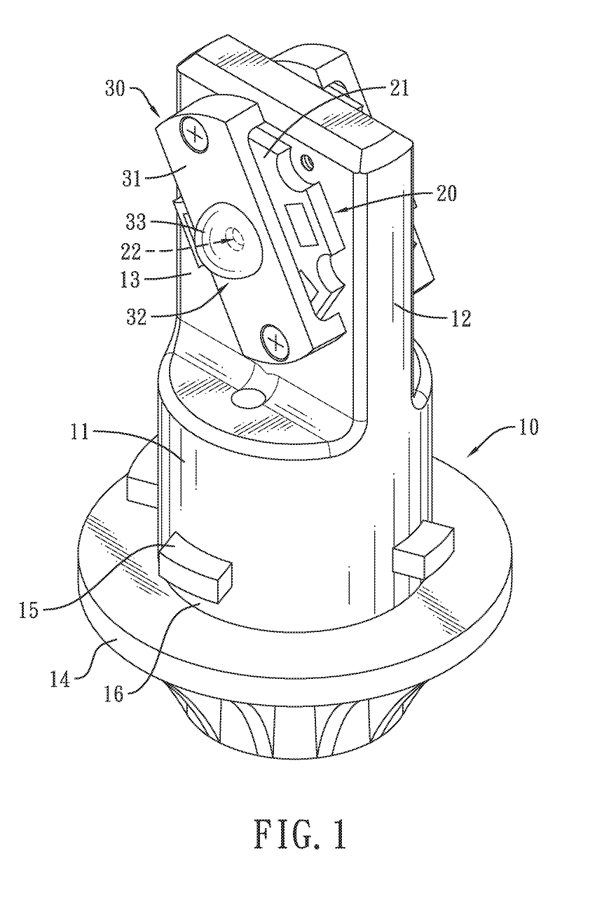

With reference to FIG. 1, a lighting device for an LED lamp in accordance with the present invention comprises a holder 10, multiple LED modules 20 and multiple light-homogenized elements 30.

With reference to FIG. 1, the holder 10 has a base 11 and a pillar 12. The pillar 12 is mounted on the base 11 and has an axis 60, a distal tip and multiple working surfaces 13. The axis 60 is defined axially through the pillar 12 and the base 11. The working surfaces 13 are formed in an outer side surface of the pillar 12 and are arranged around the axis 60 of the pillar 12.

The LED modules 20 are respectively mounted on the working surfaces 13 of the holder 10 and each LED module 20 has a circuit board 21 and at least one LED 22. Each circuit board 21 is mounted on a respective one of the working surfaces 13 of the holder 10. The at least one LED 22 is mounted on a respective one of the circuit boards 21.

The light-homogenized elements 30 are respectively mounted on the working surfaces 13 of the holder 10, and each light-homogenized element 30 has a body 31 and a lens 32. Each body 31 is mounted on a corresponding one of the working surfaces 13 of the holder 10 and extends across a corresponding one of the circuit boards 21. Each lens 32 is formed in the body 10 and has a light input surface facing the at least one LED 22 of a corresponding one of the LED modules 20. Each lens 32 has a light output surface being a convex surface.

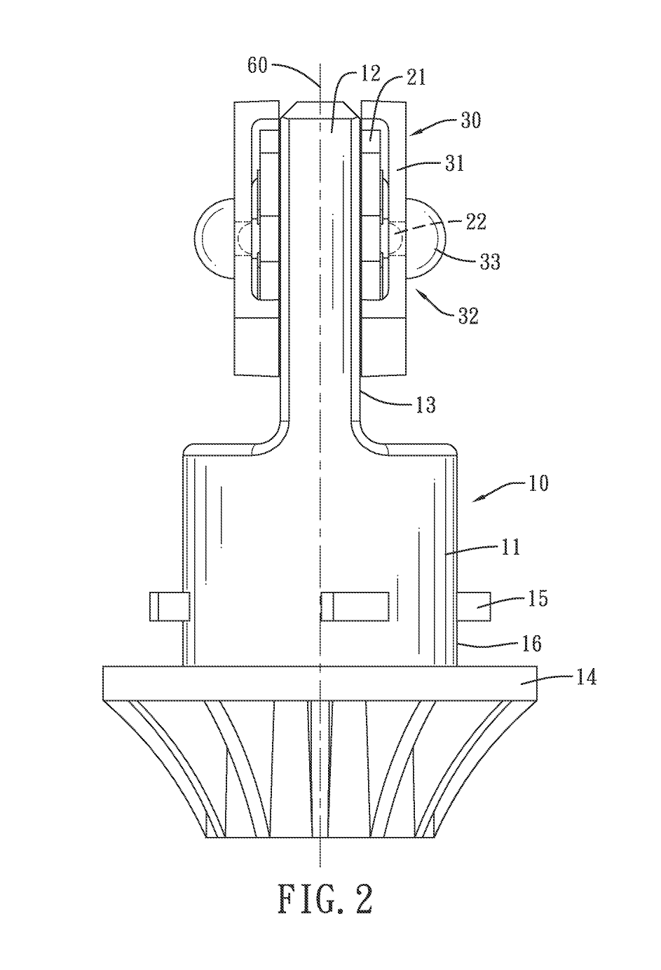

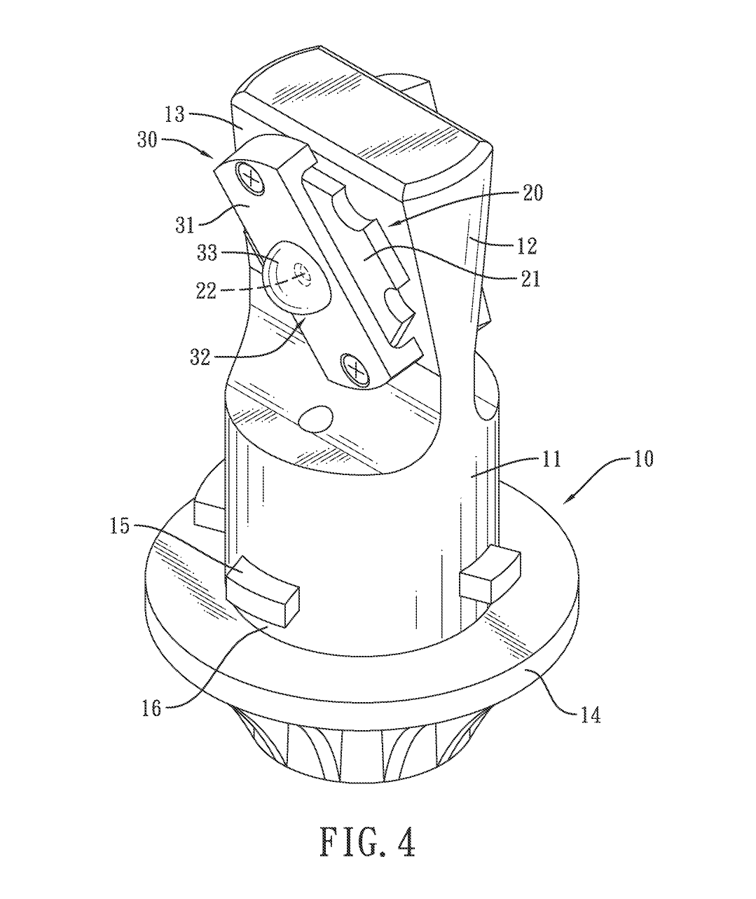

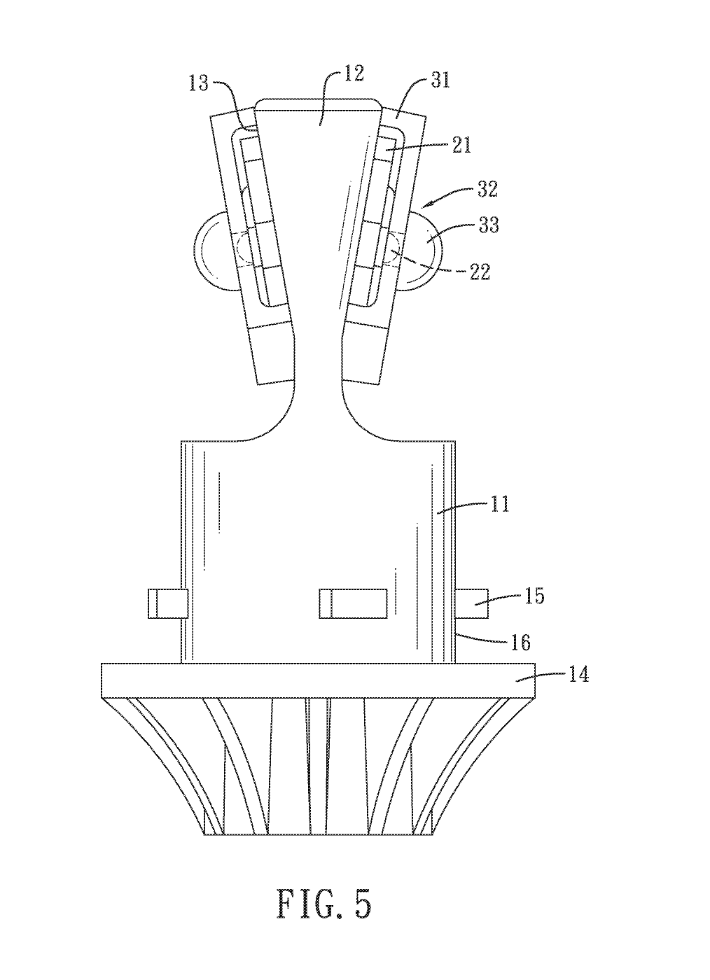

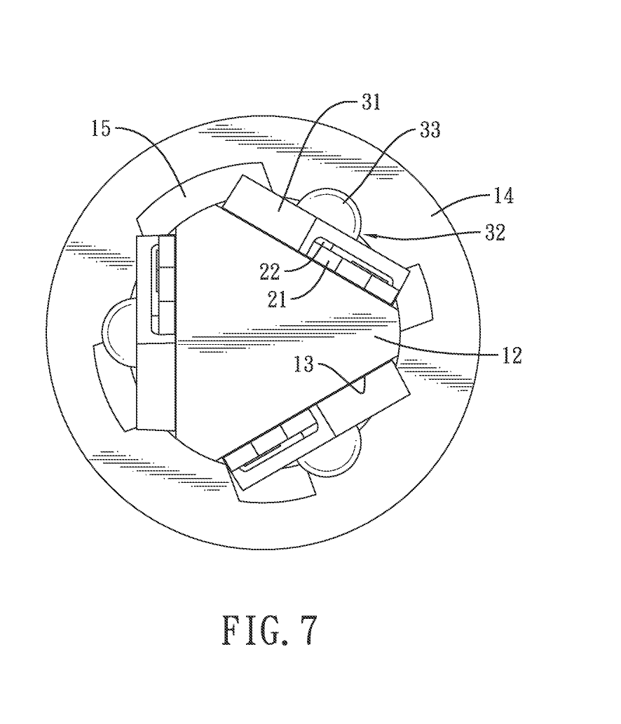

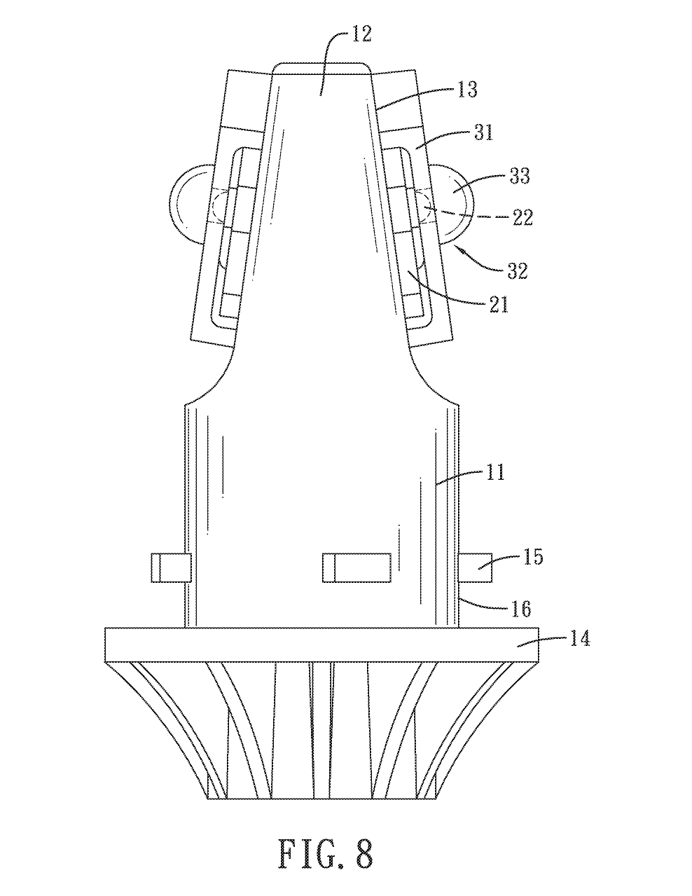

With reference to FIGS. 2 and 7, each working surface 13 is a perpendicular side surface that is parallel to the axis 60 of the pillar 12. In addition, the pillar 12 has a polygonal cross section liked a rectangle, a triangle or a pentagon. With reference to FIGS. 4 and 5, each working surface 13 is an inclined side surface that tapers outwardly towards the distal tip of the pillar 12. Alternatively, with reference to FIG. 8, each working surface 13 is an inclined side surface that tapers inwardly towards the distal tip of the pillar 12. The inclined angle of each of the working surfaces 13 depends on the using requirements. With reference to FIGS. 4 and 5, the thickness of the pillar 12 is decreased from the distal tip of the pillar 12 to the base 11. Alternatively, with reference to FIG. 8, the thickness of the pillar 12 is increased from the distal tip of the pillar 12 to the base 11.

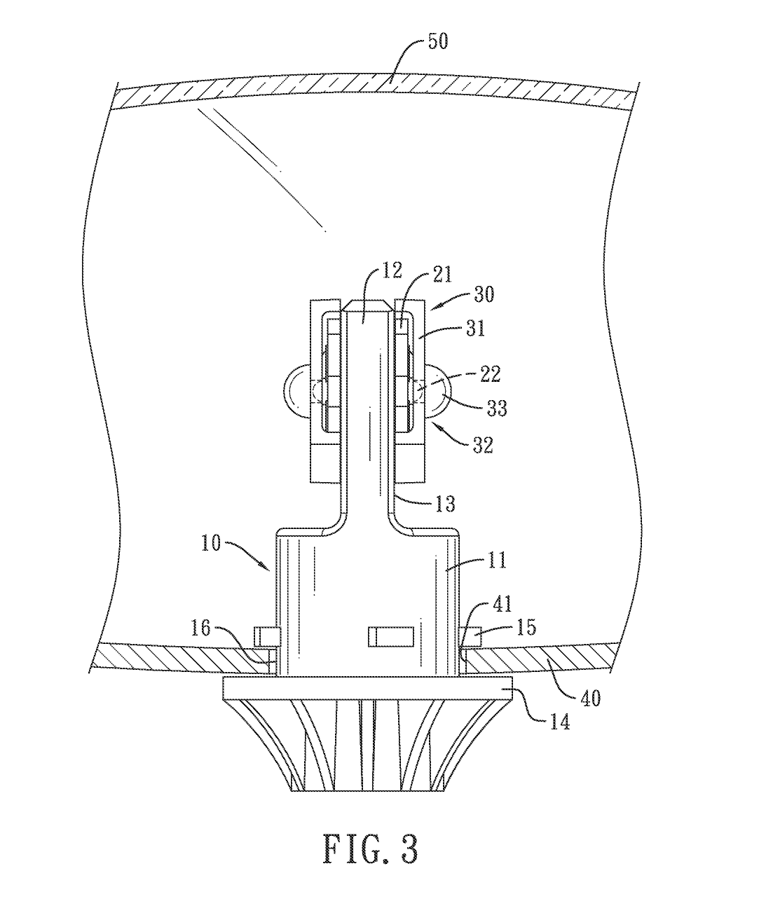

With reference to FIG. 2, the base 11 has a flange 14, multiple retainers 15 and a connecting groove 16. The flange 14 is formed around and protrudes from an outer side surface of the base 11. The retainers 15 are formed radially on the outer side surface of the base. The connecting groove 16 is defined between the flange 14 and the retainers 15 and around the outer side surface of the base 11. As shown in FIG. 3, the base 11 is inserted into a seat 40 which define notches corresponding to the retainers 15 whereby the retainers 15 are aligned with the notches to permit entry of the base 11 into the seat 40 until the flange 14 abuts the seat 40, whereafter the holder 10 is slightly rotated relative to the seat 40 such that the holder 10 is held securely in the seat 40.

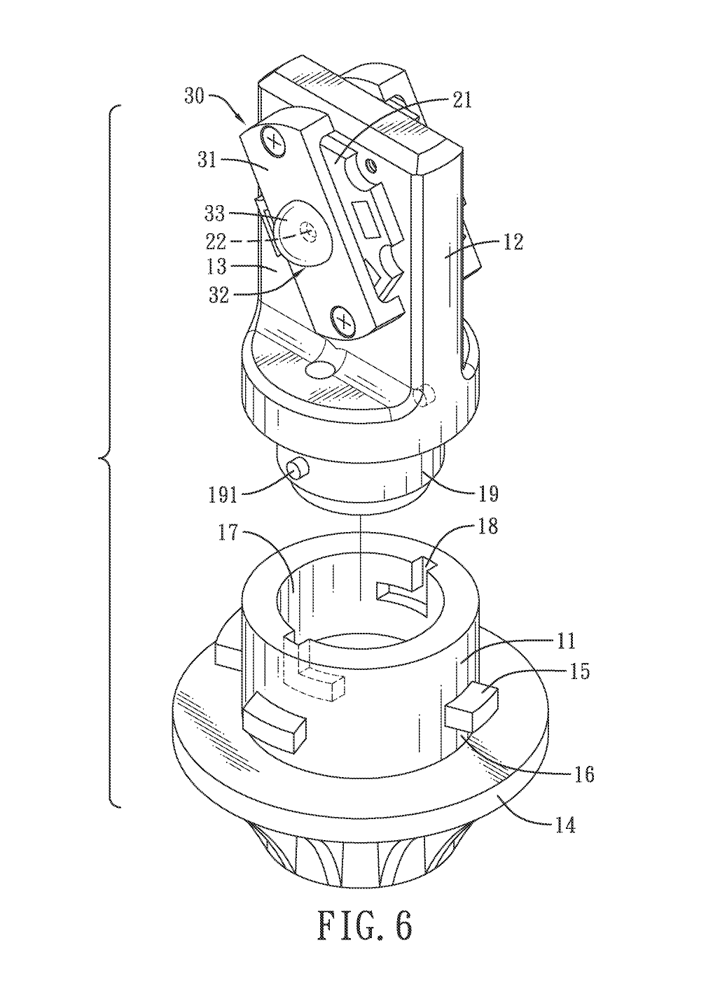

With reference to FIG. 1, the pillar 12 is integrated with the base 11. Alternatively, with reference to FIG. 6, the pillar 12 can be mounted on and be separated from the base 11. The base 11 has a bayonet socket 17 and at least one first engaging element into which at least one bayonet pin 19 is engaged and received. The bayonet socket 17 is formed in an end of the base 11. The at least one first engaging element 18 is formed in an inner side surface of the bayonet socket 17. The pillar 12 has a protrusion 19 and at least one second engaging element 191. The protrusion 19 protrudes from the rear end of the pillar 12 and is mounted in and extends into the bayonet socket 17 of the base 11. The second engaging elements 191 formed on an outer side surface of the protrusion 19 to correspondingly and releasingly mate with a corresponding one of the first engaging elements 18 of the bayonet socket 17. The at least one first engaging element 18 is a bayonet recess and the at least one second engaging element 191 is a bayonet pin. Alternatively, the at least one first engaging element 18 is a bayonet pin and the at least one second engaging element 191 is a bayonet recess.

With reference to FIG. 3, the lighting device for an LED lamp is mounted on the seat 40, and then a lampshade 50 is mounted on the seat 40 and outside the lighting device. A chamber is defined between the seat 40 and the lampshade 50. The seat 40 has a hole 41 in communication with the chamber. The pillar 12 is inserted into the seat 40 via the hole 41. A part of the seat 40 at the hole 41 extends in the connecting groove 16 between the flange 14 and the retainers 15 to install the lighting device. Therefore, the distal tip of the pillar 12 faces the lampshade 50. The light emitting from the at least one LED 22 of the lighting device passes through a corresponding one of the lenses 32 and out from the lampshade 50.

Accordingly, the at least one LED 22 is positioned on a corresponding one of the working surfaces 13 to increase the illumination of the side area of the LED lamp, and the light-homogenized effect of the light emitted from the lighting device is improved by the lenses 32 of the light-homogenized elements 30.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A lighting device for an LED lamp comprising:
a holder having
a base; and
a pillar with a distal tip and mounted on the base and having
an axis defined axially through the pillar and the base; and
multiple working surfaces formed in an outer side surface of the pillar and arranged around the axis of the pillar;
multiple LED modules respectively mounted on the working surfaces of the holder and each LED module having
a circuit board mounted on a respective one of the working surfaces of the holder; and
at least one LED mounted on the circuit board; and
multiple light-homogenized elements respectively mounted on the working surfaces of the holder and each light-homogenized element having
a body mounted on a corresponding one of the working surfaces of the holder and extending across a corresponding one of the circuit boards; and
a lens formed in the body and having a light input surface facing the at least one LED of a corresponding one of the LED modules.

2. The lighting device as claimed in claim 1, wherein each working surface is a perpendicular side surface that is parallel to the axis of the pillar.

3. The lighting device as claimed in claim 2, wherein the pillar has a polygonal cross section.

4. The lighting device as claimed in claim 1, wherein each working surface is an inclined side surface that tapers inwardly towards the distal tip of the pillar.

5. The lighting device as claimed in claim 1, wherein each working surface is an inclined side surface that tapers outwardly towards the distal tip of the pillar.

6. The lighting device as claimed in claim 1, wherein
the base has
a flange formed around and protruded from an outer side surface of the base;
multiple retainers formed on the an outer side surface of the base and ranked radially; and
a connecting groove defined between the flange and the retainers and around the outer side surface of the base.

7. The lighting device as claimed in claim 2, wherein
the base has
a flange formed around and protruded from an outer side surface of the base;
multiple retainers formed on the an outer side surface of the base and ranked radially; and
a connecting groove defined between the flange and the retainers and around the outer side surface of the base.

8. The lighting device as claimed in claim 4, wherein
the base has
a flange formed around and protruded from an outer side surface of the base;
multiple retainers formed on the an outer side surface of the base and ranked radially; and
a connecting groove defined between the flange and the retainers and around the outer side surface of the base.

9. The lighting device as claimed in claim 5, wherein
the base has
a flange formed around and protruded from an outer side surface of the base;
multiple retainers formed on the an outer side surface of the base and ranked radially; and
a connecting groove defined between the flange and the retainers and around the outer side surface of the base.

10. The lighting device as claimed in claim 1, wherein the pillar is integrated with the base.

11. The lighting device as claimed in claim 4, wherein the pillar is integrated with the base.

12. The lighting device as claimed in claim 5, wherein the pillar is integrated with the base.

13. The lighting device as claimed in claim 9, wherein the pillar is integrated with the base.

14. The lighting device as claimed in claim 1, wherein
the base has
a bayonet socket formed in an end of the base; and
at least one first engaging element formed in an inner side surface of the bayonet socket; and
the pillar has at least one second engaging element to correspondingly and releasingly mate with the first engaging element of the bayonet socket, and each second engaging element is a bayonet pin.

15. The lighting device as claimed in claim 2, wherein
the base has
a bayonet socket formed in an end of the base; and
at least one first engaging element being a bayonet recess formed in an inner side surface of the bayonet socket; and
the pillar has at least one second engaging element to correspondingly and releasingly mate with the first engaging element of the bayonet socket, and each second engaging element is a bayonet pin.

16. The lighting device as claimed in claim 3, wherein
the base has
a bayonet socket formed in an end of the base; and
at least one first engaging element being a bayonet recess formed in an inner side surface of the bayonet socket; and
the pillar has at least one second engaging element to correspondingly and releasingly mate with the first engaging element of the bayonet socket, and each second engaging element is a bayonet pin.

17. The lighting device as claimed in claim 4, wherein
the base has
a bayonet socket formed in an end of the base; and
at least one first engaging element being a bayonet recess formed in an inner side surface of the bayonet socket; and
the pillar has at least one second engaging element to correspondingly and releasingly mate with the first engaging element of the bayonet socket, and each second engaging element is a bayonet pin.

18. The lighting device as claimed in claim 5, wherein
the base has
a bayonet socket formed in an end of the base; and
at least one first engaging element being a bayonet recess formed in an inner side surface of the bayonet socket; and
the pillar has at least one second engaging element to correspondingly and releasingly mate with the first engaging element of the bayonet socket, and each second engaging element is a bayonet pin.

19. The lighting device as claimed in claim 6, wherein
the base has
a bayonet socket formed in an end of the base; and
at least one first engaging element being a bayonet recess formed in an inner side surface of the bayonet socket; and
the pillar has at least one second engaging element to correspondingly and releasingly mate with the first engaging element of the bayonet socket, and each second engaging element is a bayonet pin.

20. The lighting device as claimed in claim 9, wherein
the base has
a bayonet socket formed in an end of the base; and
at least one first engaging element being a bayonet recess formed in an inner side surface of the bayonet socket; and
the pillar has at least one second engaging element to correspondingly and releasingly mate with the first engaging element of the bayonet socket, and each second engaging element is a bayonet pin.
